(19) United States
(12) Patent Application Publication
(10) Pub. No.: US 2007/0203320 A1
(43) Pub. Date: Aug. 30, 2007

(54) Melt-processable polyurethanes and a process for their production

(75) Inventors: Eva Gestermann, Leverkusen (DE); Wolfgang Brauer, Leverkusen (DE); Hans-Georg Wussow, Dusseldorf (DE); Henricus Peerlings, Solingen (DE); Govert Woeste, Dusseldorf (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/709,411

(22) Filed: Feb. 22, 2007

(30) Foreign Application Priority Data
Feb. 28, 2006 (DE) 102006009096.9

(51) Int. Cl. C08G 18/00

(52) U.S. Cl. 528/44

(57) ABSTRACT

Melt-processable polyurethanes containing certain waxes are produced. These polyurethanes are useful for the production of films, coatings and injection moldings.

### BACKGROUND OF THE INVENTION

The present invention relates to melt-processable polyurethanes containing certain waxes, a process for their production and their use for the production of films, coatings and injection moldings.

Thermoplastic polyurethane elastomers (TPUs) are of industrial importance because they display excellent mechanical properties and can be melt-processed at low cost. Their mechanical properties can be varied over a broad range by using different chemical constituents. Summarized descriptions of TPUs, their properties and applications can be found in Kunststoffe 68 (1978), pp. 819-825 and Kautschuk, Gummi, Kunststoffe 35 (1982), pp. 568-584.

TPUS are built up from linear polyols, usually polyester or polyether polyols, organic diisocyanates and short-chain diols (chain extenders). To accelerate the formation reaction, catalysts can also be added. The molar ratios of the constituents can be varied over a broad range, enabling the properties of the product to be adjusted. Depending on the molar ratio of polyol(s) to chain extender(s), products with a wide range of Shore hardnesses may be obtained. The melt-processable polyurethane elastomers can be built up either stepwise (prepolymer process) or by the simultaneous reaction of all the components in one step (one-shot process). In the prepolymer process, an isocyanate-containing prepolymer is formed from the polyol and the diisocyanate and is reacted with the chain extender in a second step. The TPUs can be produced continuously or batchwise. The best-known industrial production processes are the belt process and the extruder process.

In addition to catalysts, auxiliary substances and additives can also be added to the TPU components. Waxes, for example, perform important tasks both during the industrial production of the TPUs and during their processing. The wax acts as a friction-reducing internal and external lubricant, thus improving the flow properties of the TPU. In addition, as a release agent, it should prevent the TPU from adhering to the surrounding material (e.g., the mold) and should act as a disperser for other additives, e.g., pigments and antiblocking agents.

In the prior art, fatty acid esters such as stearic acid ester and montanic acid ester and the metal soaps thereof are examples of useful waxes, as are fatty acid amides such as stearamides and oleamides, or polyethylene waxes. An overview of the waxes used in thermoplastics can be found in H. Zweifel (ed.): Plastics Additives Handbook, 5^{th} edition, Hanser Verlag, Munich 2001, pp. 443 ff.

Up to the present, amide waxes which have a good non-stick action, particularly ethylene bisstearamide, have been used substantially in TPUs. In addition, montanic ester waxes which display good lubricant properties with low volatility are used (See, e.g., EP-A 308 683; EP-A 670 339; JP-A 5 163 431). A disadvantage of amide waxes when used in TPUs, however, is their tendency to migrate. After a period of time, this leads to plate out on the workpiece, which leads to optical impairment, particularly in thin-walled applications such as films, and results in undesirable changes to surface-dependent properties. The use of montanic ester waxes is restricted by haze limits that are too low. Furthermore, even at a relatively high concentration, their non-stick action is inadequate.

It has been possible to achieve improvements by using ester and amide combinations (DE-A 19 607 870) and by using special wax mixtures of montanic acid derivatives and fatty acid derivatives (DE-A 19 649 290). Although TPUs which contain these waxes do display a markedly lower tendency to form surface deposits, these waxes also migrate under certain climatic conditions, which is unacceptable.

### SUMMARY OF THE INVENTION

The object the present invention was therefore to provide a TPU which, regardless of the climatic conditions, does not form any surface deposits and at the same time displays very good mold release and non-stick properties.

It was possible to achieve this object by incorporating specific additives into the TPUs of the present invention which additives are described more fully herein.

### DETAILED DESCRIPTION OF THE INVENTION

The present invention is directed to melt-processable polyurethanes which are produced from the following components:
A) one or more organic diisocyanates,
B) one or more linear hydroxyl-terminated polyols with weight-average molecular weights of from 500 to 5000,
C) one or more diol chain extenders and optionally, diamine chain extenders, with molecular weights of from 60 to 490,
D) optional catalyst(s),
E) optional auxiliary substances and additives, and
F) from 0.02 to 2 wt. %, based on total weight of product, of a mixture of the reaction products of
   a) alkylene diamine(s), preferably ethylenediamine, with one or more linear fatty acids, preferably stearic and/or palmitic acid or industrial stearic acid, and
   b) alkylene diamine(s), preferably ethylenediamine, with 12-hydroxystearic acid,
   and/or
   c) alkylene diamine(s), preferably ethylenediamine, with 12-hydroxystearic acid and one or more linear fatty acids, preferably stearic and/or palmitic acid or industrial stearic acid.

These components are used in amounts such that the molar ratio of the NCO groups in A) to the isocyanate-reactive groups in B) and C) is from 0.9:1 to 1.2:1.

The mixture F) includes the reaction products of alkylene diamine with a) and b) and/or c) in a preferred ratio of 1-95 wt. % (preferably 1-85 wt. %, most preferably 5-75 wt. %) to 1-95 wt. % (preferably 1-85 wt. %, most preferably 5-75 wt. %) to 0-50 wt. % (preferably 0-40 wt. %) based on the total weight of the mixture F, the sum of the reaction products equalling 100 wt. %.

Industrial stearic acid contains from 20 to 50 wt. % palmitic acid and from 50 to 80 wt. % stearic acid.

Suitable organic diisocyanates A) include, for example, aliphatic, cycloaliphatic, araliphatic, heterocyclic and aromatic diisocyanates, such as those described in Justus Liebigs Annalen der Chemie, 562, pp. 75-136.

Specific examples of suitable diisocyanates include: aliphatic diisocyanates, such as hexa-methylene diisocyanate; cycloaliphatic diisocyanates, such as isophorone diisocyanate, 1,4-cyclohexane diisocyanate, 1-methyl-2,4-cyclohexane diisocyanate and 1-methyl-2,6-cyclohexane diisocyanate together with the corresponding mixtures of isomers, 4,4′-dicyclohexylmethane diisocyanate, 2,4′-dicyclohexylmethane diisocyanate and 2,2′-dicyclohexylmethane diisocyanate together with the corresponding mixtures of isomers; aromatic diisocyanates, such as 2,4-toluene diisocyanate, mixtures of 2,4-toluene diisocyanate and 2,6-toluene diisocyanate, 4,4′-diphenylmethane diisocyanate, 2,4′-diphenylmethane diisocyanate and 2,2′-diphenylmethane diisocyanate, mixtures of 2,4′-diphenylmethane diisocyanate and 4,4′-diphenylmethane diisocyanate, urethane-modified liquid 4,4′-diphenylmethane diisocyanates and 2,4′-diphenylmethane diisocyanates, 4,4′-diisocyanatodiphenylethane-(1,2) and 1,5-naphthylene diisocyanate. 1,6-hexamethylene diisocyanate, isophorone diisocyanate, dicyclohexylmethane diisocyanate, diphenylmethane diisocyanate isomer mixtures with a 4,4′-diphenylmethane diisocyanate content of >96 wt. % are preferred and 4,4′-diphenylmethane diisocyanate and 1,5-naphthylene diisocyanate are most preferred. These diisocyanates can be used individually or in the form of mixtures with one another. They can also be used together with up to 15 wt. % (based on the total quantity of diisocyanate) of a polyisocyanate, e.g., triphenylmethane-4,4′,4″-triisocyanate or polyphenyl polymethylene polyisocyanates.

Linear hydroxyl-terminated polyols with a molecular weight of from 500 to 5000 are used as component B). As a result of their production, these often contain small quantities of nonlinear compounds. They are often therefore also referred to as “substantially linear polyols”. Polyester, polyether or polycarbonate diols or mixtures thereof are preferred.

Suitable polyether diols can be produced by reacting one or more alkylene oxides having 2 to 4 carbon atoms in the alkylene group with a starter molecule containing two bound active hydrogen atoms. Examples of suitable alkylene oxides are: ethylene oxide, 1,2-propylene oxide, epichlorohydrin, 1,2-butylene oxide and 2,3-butylene oxide. Ethylene oxide, propylene oxide and mixtures of 1,2-propylene oxide and ethylene oxide are preferred. The alkylene oxides can be used individually, alternately in succession or as mixtures. Suitable starter molecules are, e.g., water; amino alcohols, such as N-alkyldiethanolamines, e.g. N-methyldiethanolamine; and diols, such as ethylene glycol, 1,3-propylene glycol, 1,4-butanediol and 1,6-hexanediol. Mixtures of starter molecules can optionally also be used. Suitable polyether diols also include the hydroxyl group-containing polymerization products of tetrahydrofuran. Trifunctional polyethers can also be employed in proportions of from 0 to 30 wt. %, based on the bifunctional polyethers, but in no more than a quantity sufficient to give rise to a melt-processable product. The substantially linear polyether diols possess molecular weights of from 500 to 5000. They can be employed both individually and in the form of mixtures with one another.

Suitable polyester diols can be produced e.g. from dicarboxylic acids with 2 to 12 carbon atoms, preferably 4 to 6 carbon atoms, and polyhydric alcohols. Suitable dicarboxylic acids are e.g.: aliphatic dicarboxylic acids, such as succinic acid, glutaric acid, adipic acid, suberic acid, azelaic acid and sebacic acid, and aromatic dicarboxylic acids, such as phthalic acid, isophthalic acid and terephthalic acid. The dicarboxylic acids can be employed individually or as mixtures, e.g. in the form of a succinic, glutaric and adipic acid mixture. To produce the polyester diols, it may be advantageous to use the corresponding dicarboxylic acid derivatives, such as carboxylic acid diesters with 1 to 4 carbon atoms in the alcohol group, carboxylic acid anhydrides or carboxylic acid chlorides instead of the dicarboxylic acids. Examples of polyhydric alcohols are glycols with 2 to 10, preferably 2 to 6 carbon atoms, such as ethylene glycol, diethylene glycol, 1,4-butanediol, 1,5-pentanediol, 1,6-hexanediol, 1,10-decanediol, 2,2-dimethyl-1,3-propanediol, 1,3-propanediol and dipropylene glycol. Depending on the properties desired, the polyhydric alcohols can be used alone or optionally in a mixture with one another. Esters of carbonic acid with the above diols are also suitable, particularly those with 4 to 6 carbon atoms, such as 1,4-butanediol or 1,6-hexanediol, condensation products of hydroxycarboxylic acids, e.g., hydroxycaproic acid, and polymerization products of lactones, e.g., optionally substituted caprolactones. Preferred polyester diols are ethanediol polyadipates 1,4-butanediol polyadipates, ethanediol 1,4-butanediol polyadipates, 1,6-hexanediol neopentyl glycol polyadipates, 1,6-hexanediol 1,4-butanediol polyadipates and polycaprolactones. The polyester diols have molecular weights of from 500 to 5000 and can be used individually or in the form of mixtures with one another.

Diols with a molecular weight of from 60 to 490 are used as chain extenders C), preferably aliphatic diols with from 2 to 14 carbon atoms, such as ethanediol, 1,6-hexanediol, diethylene glycol, dipropylene glycol and more preferably 1,4-butanediol. However, diesters of terephthalic acid with glycols having from 2 to 4 carbon atoms, such as terephthalic acid bisethylene glycol or terephthalic acid bis-1,4-butanediol, hydroxyalkylene ethers of hydroquinone, such as 1,4-di(-hydroxyethyl) hydroquinone and ethoxylated bisphenols are also suitable. The chain extender C) can also contain relatively small proportions of diamines. These include (cyclo)aliphatic diamines, such as isophorone diamine, ethylenediamine, 1,2-propylenediamine, 1,3-propylenediamine, N-methyl-1,3-propylenediamine, N,N′-dimethylethylenediamine, and aromatic diamines, such as 2,4-toluenediamine and 2,6-toluenediamine, 3,5-diethyl-2,4-toluenediamine and 3,5-diethyl-2,6-toluenediamine and primary mono-, di-, tri- or tetraalkyl-substituted 4,4′-diaminodiphenylmethanes. Mixtures of the chain extenders mentioned above can also be used. In addition, relatively small quantities of triols can be added.

Further, conventional monofunctional compounds can also be used in small quantities, e.g., as chain terminators or mold release agents. Alcohols, such as octanol and stearyl alcohol, or amines, such as butylamine and stearylamine, are examples.

To produce the TPUs of the present invention, the constituents can optionally be reacted in the presence of catalysts, auxiliary substances and additives, in quantities such that the equivalence ratio of NCO groups to the sum of the NCO-reactive groups, particularly the OH groups of the low molecular-weight diols/triols and polyols, is from 0.9:1.0 to 1.2:1.0, preferably from 0.95:1.0 to 1.10:1.0.

The TPUs of the present invention contain as a particularly preferred wax component F) from 0.02 to 2 wt. %, preferably from 0.05 to 1.2 wt. %, based on the total weight of TPU, of a mixture of the reaction products of ethylenediamine with a) industrial stearic acid (containing 20-50 wt. % palmitic acid and 50-80 wt. % stearic acid) and b) 12-hydroxystearic acid in a molar ratio a:b of from about 0.05:0.95 to about 0.95:0.05, preferably of from about 0.25:0.75 to about 0.75:0.25.

The reaction can be conducted in accordance with conventional amidation processes (See, e.g., Houben und Weyl, Methoden der organischen Chemie, 4^{th} edition, Thieme Publ. 1952, 8, pages 647-671). In this case, the acids a) and b) may be reacted jointly with an equimolar quantity of ethylenediamine or reacted individually and the resulting amides subsequently mixed. Depending on the production process, mixtures are formed containing the following reaction products in various proportions:

| | |
|---|---|
| C16-EDA-C16 | ethylene bispalmitamide |
| C16-EDA-C18 | ethylene palmityl stearamide |
| C16-EDA-C18OH | ethylene palmityl hydroxystearamide |
| C18EDA-C18 | ethylene bisstearamide |
| C18-EDA-C18OH | ethylene stearyl hydroxystearamide |
| C18OH-EDA-C18OH | ethylene bishydroxystearamide |

Suitable catalysts D) for TPU production include any of the conventional tertiary amines known to those skilled in the art, such as triethylamine, dimethylcyclohexylamine, N-methylmorpholine, N,N′-dimethylpiperazine, 2-(dimethylaminoethoxy)ethanol, diazabicyclo-[2.2.2]-octane, organic metal compounds, such as titanic acid esters, iron compounds, tin compounds (e.g., tin diacetate, tin dioctoate, tin dilaurate or the tin dialkyl salts of aliphatic carboxylic acids, such as dibutyltin diacetate, dibutyltin dilaurate and similar catalysts). Preferred catalysts are organic metal compounds, particularly titanic acid esters, iron compounds and/or tin compounds.

In addition to the TPU components, the waxes and the catalysts, other auxiliary substances and additives E) may also be added. The following are mentioned as examples: lubricants, such as fatty acid esters, their metal soaps, fatty acid amides and silicone compounds; antiblocking agents; inhibitors; stabilizers against hydrolysis, light, heat and discoloration; flame retardants; dyes; pigments; inorganic or organic fillers; and reinforcing agents. Reinforcing agents are preferably fibrous reinforcing materials, such as inorganic fibers, which are produced in accordance with the prior art and can also be provided with a size. Further details on the above-mentioned auxiliary substances and additives can be found, e.g., in J. H. Saunders, K. C. Frisch: “High Polymers”, Volume XVI, Polyurethane, parts 1 and 2, Interscience Publishers 1962 and 1964 respectively; R. Gächter, H. Müller (ed.): Taschenbuch der Kunststoff-Additive, 3^{rd} edition, Hanser Verlag, Munich 1989; and DE-A 29 01 774.

Other additives that can be incorporated into the TPU are thermoplastics, e.g., polycarbonates and acrylonitrile/butadiene/styrene terpolymers, particularly ABS. Other elastomers, such as rubber, ethylene/vinyl acetate copolymers, styrene/butadiene copolymers and other TPUs, can also be used. Commercial plasticizers, such as phosphates, phthalates, adipates, sebacates and alkylsulfonates, are also suitable for incorporation.

The present invention also provides a process for the production of the TPUs of the present invention. The TPUs of the present invention can be produced continuously in the so-called extruder process, e.g. in a multi-screw extruder. The metering of the TPU components A), B) and C) can take place simultaneously, i.e. in the one-shot process, or consecutively, i.e. by a prepolymer process. The prepolymer can be either charged batchwise or produced continuously in a section of the extruder or in a separate, upstream prepolymer unit.

The waxes F) can be metered continuously into the TPU reaction in the extruder, preferably into the first extruder housing. The metering takes place either at room temperature in the solid state of aggregation or in liquid form at 70 to 120° C. However, it is also possible to meter the waxes into the TPU which has been produced in advance and melted again in an extruder, and to compound them. In another variant, the waxes can be homogeneously incorporated into the polyol component before the reaction, preferably at a temperature of from 70 to 120° C., and metered into the other components together with the polyol component.

The TPU products obtained in this way possess good mechanical and elastic properties. In addition, they have excellent processing properties.

The excellent non-stick properties of the TPUs of the present invention become apparent as ease of demolding when processed to form injection moldings. The low migration tendency means that there is no plate out under widely varying storage conditions, even after a long storage period.

Films and sheets of great homogeneity can be produced from the melt from the TPUs of the present invention. Due to their low adhesive tendency, these films and sheets have very good non-stick properties. Since no migration occurs, the optical impression and surface properties are not impaired even after a long storage period.

The TPUs of the present invention can be also used as coatings.

The invention will be explained in more detail with the aid of the following examples.

### EXAMPLES 1 TO 6

### TPU Formulation

| | | |
|---|---|---|
| Poly(1,4-butanediol adipate) (molecular weight | 100 | parts by weight |
| approx. 2200): | | |
| Butanediol: | 11 | parts by weight |
| Diphenylmethane diisocyanate (MDI liquid, | 42 | parts by weight |
| 50° C.): | | |
| Titanium acetylacetonate: | 7.5 | ppm |

### TPU Production

The TPU was produced in a continuous TPU reaction in a tubular mixer/extruder (ZSK 53 extruder, Wemer/Pfleiderer) by the known prepolymer process as described in EP-A 571 830 and EP-A 571 828. The housing temperatures of the 13 housings were from 100° C. to 220° C. The speed of the screw was adjusted to 290 rpm. The overall metering rate was 75 kg/h. The TPU was extruded as a melt strand, cooled in water and granulated.

The waxes or the mixtures were added in accordance with Tables 1 and 2 in the continuous TPU production described above (ZSK housing 1).

### EXAMPLE 7

### TPU Production

100 parts by weight of poly(1,4-butanediol adipate) (molecular weight approx. 2200) at a temperature of 180° C., in which the wax mixture was dissolved, and 42 parts by weight of warm 4,4′-diphenylmethane diisocyanate (MDI) at 60° C. were charged into a reaction vessel with stirring and reacted to a conversion of >90 mole %, based on the polyol.

11 parts by weight of 1,4-butanediol were then incorporated with intensive mixing and after approx. 15 sec, the reaction mixture was poured on to a coated metal sheet and annealed at 120° C. for 30 minutes. The cast sheets were cut and granulated.

### Production of Films: Examples 8 to 10

The TPU granules were melted in a single screw extruder (30/25D Plasticorder PL 2000-6 single screw extruder, Brabender) (metering rate 3 kg/h; 185-205° C.) and extruded through a blown film die to form a tubular film.

### Production of Injection Molded Sheets 1 to 7

The TPU granules were melted in an injection molding machine (D 60 injection molding machine, 32 screw, Mannesmann AG) (melt temperature approx. 225° C.) and shaped into sheets (mold temperature 40° C.; sheet size: 125×45×2 mm).

The most important properties of the TPU moldings produced in this way are reported in Tables 1 and 2.

TABLE 1
Injection molded sheets

| | | | | Optical evaluation of plate out | | |
|---|---|---|---|---|---|---|
| | | | | Grades: | | |
| | | | | very low–low–moderate–high–very | | |
| | | | | high | | |
| | | | | After | After | After |
| | | Wax #/ | Non-stick | 2 weeks | 2 weeks | 6 months |
| Sheet | TPU | wt. % | action | at 60° C. | at 80° C. | at RT |
| 1* | 1 | 1/0.4 | Very good | Low | Very high | High |
| 2* | 2 | 1/0.7 | Very good | High | Very high | High |
| 3* | 3 | 2/0.3 | Very good | High | Low | High |
| 4 | 4 | 3/0.4 | Very good | Very low | Low | Low |
| 5 | 5 | 3/0.7 | Very low | Very low | Low | Low |
| 6* | 6 | 4/0.4 | Good | High | High | Low |
| 7 | 7 | 3/0.7 | Very good | Very low | Low | Low |

*Comparative tests
Wax 1 = Loxamid ® 3324 (ethylene bisstearamide)
Wax 2 = Abril ® Paradigm Wax 77 (stearamide ethyl stearate)
Wax 3 = wax mixture containing 7% ethylene bispalmitamide, 25% ethylene palmityl stearamide, 13% ethylene palmityl hydroxystearamide, 24% ethylene bisstearamide, 24% ethylene stearyl hydroxystearamide and 7% ethylene bishydroxystearamide; according to the invention
Wax 4 = 1:1 mixture of ethylene bisstearamide and Licowachs OP (butyl montanate, partially saponified with Ca)

TABLE 2
Films

| | | | Film evaluation | | | | |
|---|---|---|---|---|---|---|---|
| | | | | | Optical evaluation of plate out | | |
| | | | | | Deposit | Deposit | Deposit |
| | | | | | after 2 | after 2 | after 2 |
| | | Wax #/ | Adhesive | | weeks at | weeks at | months at |
| Film | TPU | wt. % | action | Homogeneity | 60° C. | 80° C. | RT |
| 8* | 1 | 1/0.4 | Very | Very good | Low | High | High |
| | | | good | | | | |
| 9 | 4 | 3/0.4 | Good | Very good | Very low | Very low | Low |
| 10 | 5 | 3/0.7 | Good | Very good | Very low | Very low | Low |

*Comparison

The results clearly show that only when using the wax mixture 3 (according to the invention) was virtually no surface deposit to be found after storage both at room temperature and at 60° C. and 80° C. The good properties of the TPUs of the present invention can be observed both in the injection moldings and in the films.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A melt-processable polyurethane produced from:
A) one or more organic diisocyanates,
B) one or more linear hydroxyl-terminated polyols with weight-average molecular weights of 500 to 5000,
C) one or more diol chain extenders and optionally diamine chain extenders with molecular weights of 60 to 490,
in the presence of
D) optionally catalysts
with the addition of
E) optional auxiliary substances and additives,
in amounts such that the molar ratio of NCO groups in A) to isocyanate-reactive groups in B) and C) is from 0.9:1 to 1.2:1,
containing from 0.02 to 2 wt. %, based on total weight of melt processable polyurethane, of
F) a mixture of reaction products of
a) alkylene diamines with one or more linear fatty acids, and
b) alkylene diamines with 12-hydroxystearic acid
and/or
c) alkylene diamines with 12-hydroxystearic acid and one or more linear fatty acids.

2. The melt-processable polyurethane of claim 1 in which
component A) is 4,4′-diphenylmethane diisocyanate, isophorone diisocyanate, 1,6-hexamethylene diisocyanate, 1,5-naphthylene diisocyanate or 4,4′-dicyclohexyl diisocyanate or a mixture thereof,
component B) is a linear polyester diol, polyether diol, polycarbonate diol or a mixture thereof
and component C) is ethylene glycol, butanediol, hexanediol, 1,4-di(betahydroxyethyl)hydroquinone, 1,4-di(betahydroxyethyl)bisphenol A or a mixture thereof.

3. A process for the continuous production of the melt-processable polyurethane if claim 1 in which the mixture F) is metered into an extruder together with the components A), B), C) and optionally D) and E).

4. The process of claim 3 in which the mixture F) is mixed into the polyol B) in advance and this mixed product is metered into the extruder together with the components A), C) and optionally D) and E).

5. A coating comprising the polyurethane of claim 1.

6. A film comprising the polyurethane of claim 1.

7. An injection molding comprising the polyurethane of claim 1.
